(19) United States
(12) Patent Application Publication
(10) Pub. No.: US 2012/0259678 A1
(43) Pub. Date: Oct. 11, 2012

(54) Method and system for computing Energy Index

(76) Inventors: Michael Charles Overturf, Washington, DC (US); Andrew William Naden, Monkton, MD (US); Wojciech Marek Chrosny, Orange, CT (US)

(21) Appl. No.: 13/438,790

(22) Filed: Apr. 3, 2012

Related U.S. Application Data
(60) Provisional application No. 61/472,539, filed on Apr. 6, 2011.

(51) Int. Cl. G06Q 10/06

(52) U.S. Cl. 705/7.36

(57) ABSTRACT

An Energy Index that combines a measure of enterprise energy efficiency and a measure of sufficiency into a single energy index that will enable establishment and achievement of both energy efficiency and sufficiency. Traditionally enterprises monitored energy efficiency without consideration of sufficiency resources. A new Index is described that enables to monitor the performance of the on-site energy generation resources (sufficiency resources) and their contribution to the economic performance of the enterprise.

This application refers to provisional application No. 61/472,539 with the same title and inventors.

### BACKGROUND OF THE INVENTION

The traditional metrics of energy efficiency used by the industry take into account the economic output of the enterprise expressed in number of standard product units or dollars per energy unit or energy cost. While efficiency measures are good at monitoring and planning efficiency improvement projects, these metric lack capabilities to express enterprise's energy self-sufficiency. This is important for two reasons:
(1) With wider development of distributed generation (DG) energy systems, the enterprise management needs a measure that provides indication of an economical balance between both energy efficiency and a measure of self-sufficiency, particularly sufficient renewable energy.
(2) the desire of enterprises to be more sustainable requires identifying and securing a sustainable energy supply. A market-based energy supply features an absorbed cost chain that is subject to inflation. A sufficient energy supply has a lower or no absorbed cost chain, yet offers greater energy conversion efficiency, so it is inherently more sustainable.
(3) Business managers continue to describe energy risk as a potential source of adverse impact on their financial results. The combination of efficiency and sufficiency, in the form of an index, provides a tool to create a business process with the goal of driving energy risk to zero by reducing or eliminating demand variance (waste), and reducing or eliminating absorbed cost.

Portfolio management systems currently may track costs and effective energy efficiency. Using the described energy index, these information management systems can be made more effective and support a continuous energy productivity improvement process.

### SUMMARY OF THE INVENTION

The index described in this patent combines the traditional energy efficiency ratio with a sufficiency ratio. A sufficiency ratio is defined as the proportion of controlled or on-site generated energy to the total energy required to create value for a business' customers. An efficiency ratio is the relationship of enterprise economic output to the cost of energy required to achieve that output.

The Energy Index is calculated using a computerized energy monitoring system and it can provide historical trends as well as means for forecasting and defining management objectives for continuous energy productivity improvement.

### OBJECTS OF THE INVENTION

One object of the invention is to provide a single indicator that numerically shows the trend of increasing or decreasing enterprise energy productivity.

Another object of the invention is to provide a method of identifying required energy cost or energy demand improvements for future or anticipate economic output of the enterprise.

Yet another object of the invention is to facilitate the setting of future goals of enterprise energy productivity.

Yet another object of the invention is to use cost optimization of energy portfolios that combine market and onsite generation into one single private portfolio.

Yet another object of the invention is to implement the calculation of the Energy Index on an energy portfolio management information system.

### BRIEF DESCRIPTION OF DRAWINGS

FIG. 1 is the mathematical formula for the Energy Index.

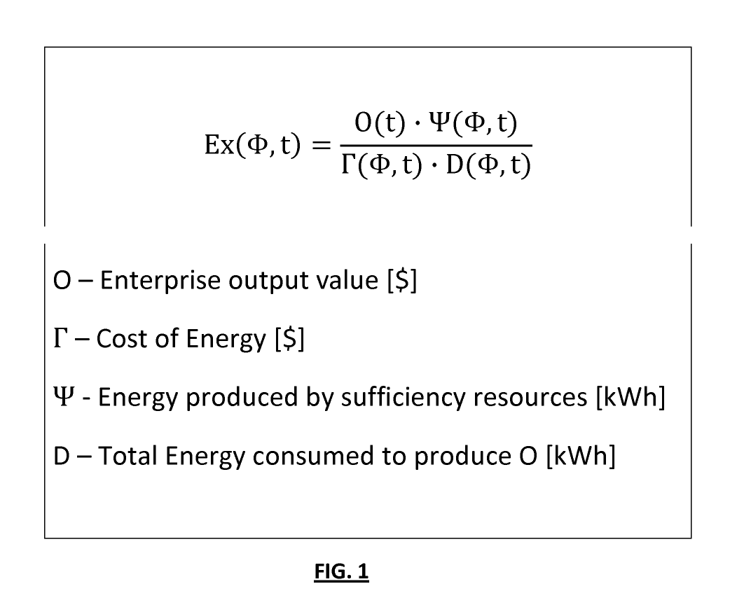

FIG. 2 is the computer system implementation of the Energy Index.

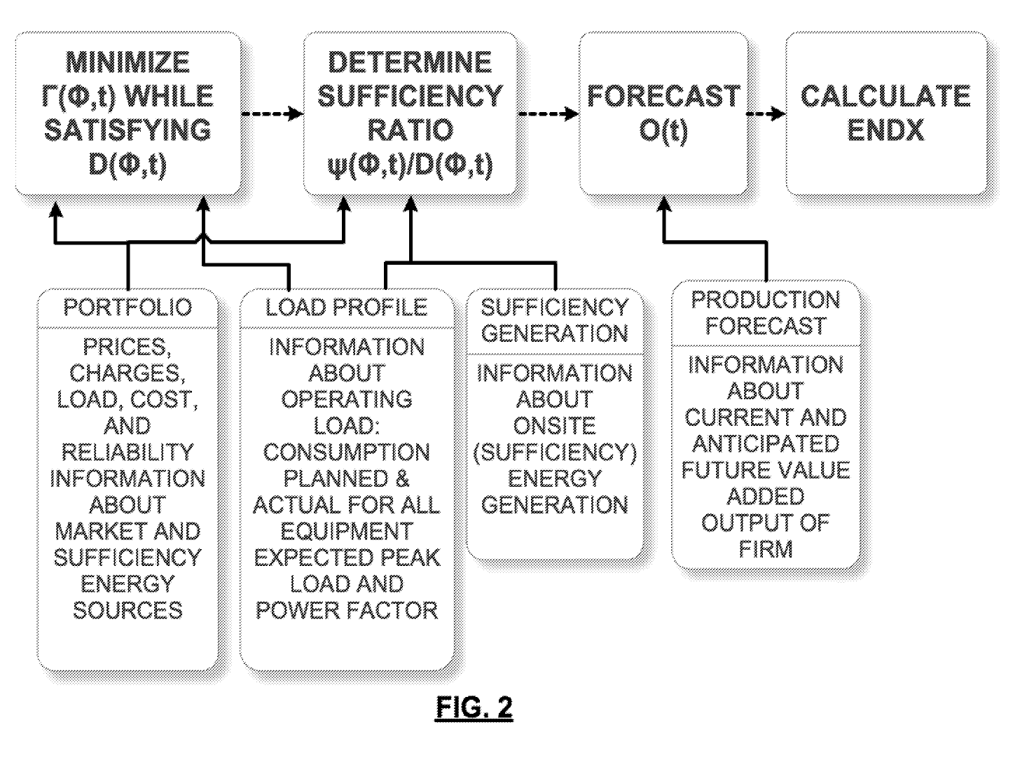

FIG. 3 is the continuous process improvement process integrating the Energy Index in management of Energy Efficiency and Sufficiency.

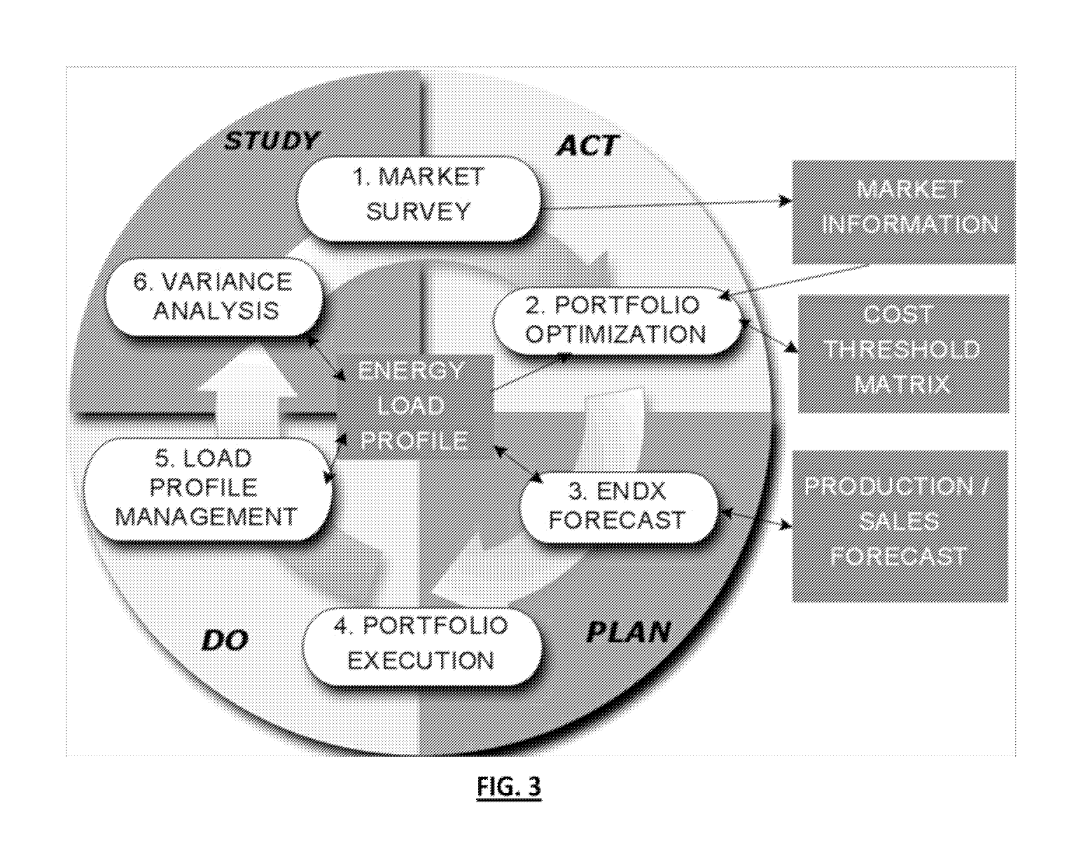

What is claimed is:

1. An energy index that combines economic output of an enterprise cost of energy, energy consumption and energy production from on-site resources into a single management indicator of energy performance.

2. An energy index according to claim 1, wherein, the index is implemented in a computerized system for computation of current, historical and forecasted values of the index.

3. An energy index according to claim 2, wherein, the index is used to assess financial benefits of different energy sourcing strategies including onsite/distributed generation.

4. An energy index according to claim 3, wherein, the index is used to evaluate the ability to implement different energy sourcing strategies at minimal cost.

5. An energy index according to claim 4, wherein, the index is used to manage the operation of a portfolio of energy assets.

6. An energy index according to claim 5, wherein, the index is used to direct energy efficiency improvement activities with respect to overall energy portfolio constraints

7. An energy index according to claim 1, wherein, the continuous minimization of the index is used to determined the sustainability of operational energy use.
